(19) United States
(12) Patent Application Publication
(10) Pub. No.: US 2004/0162858 A1
(43) Pub. Date: Aug. 19, 2004

(54) Transparently managed, content-centric permanent content storage

(76) Inventor: Alan Messer, Los Gatos, CA (US)

Correspondence Address: ALAN MESSER, 225 CALLE MARGUERITA, LOS GATOS, CA, 95032, US

(21) Appl. No.: 10/365,056

(22) Filed: Feb. 12, 2003

(51) Int. Cl. G06F 12/00

(52) U.S. Cl. 707/204

(57) ABSTRACT

A method for user-centric content storage that enables the permanent storage of content without user concern for data location or layout, and for ensuring data integrity transparently based on available secondary storage. A content storage device according to the present techniques includes mechanisms for mapping input content into one or more data entities according to content type; mechanisms for maintaining the mapping as content in added or changed; mechanisms for placing data entities transparently in accordance to data type; and mechanisms for transparently determining when and what data entities should be replicated without user concern.

### BACKGROUND OF THE INVENTION

1. Field of Invention

The present invention pertains to the field of content storage. More particularly, this invention related to the storage of content without user concern for storage location or layout.

2. Art Background

A wide variety of problems in computers may involve the storage of data on permanent media. For example, storage devices such as a hard disk may be used to store computer programs.

A typical storage device includes a structure known as a file system in which data is organized by the user using the computer system. For example, a disk may contain a file system allowing the computer to store data by name on behalf of the user in an organized fashion. This file system may also contain named directories to allow the computer record groupings of files as determined by the programmer of a program storing its own files or by the user of the computer system.

It is often desirable that data on a device storage device is replicated on long-term storage to prevent data loss under a variety of failure circumstances to the original storage device. For example, computer storage devices such as hard disk drives are often backed up on to tape systems as long-term replicated storage for data safety.

Prior methods for organizing user data leave the organization, relationships and layout of data directly to the user as the content is created on the computer system. In addition, prior methods leave the control of data replication to the user to select whether to replicate data, which set of data to replicate and when to replicate those sets of data.

### SUMMARY OF THE INVENTION

A method of storing content, such as personal content, is disclosed that masks the structure of storage layout and its replication from the user in an efficient manner. Where content may include photographic images in the form of computer image data, music in the form of a computer audio data, video clips in computer video data, word processor documents, and the content descriptions. A method according to the present techniques includes masking the location of data storage layout from the user using media abstractions and if necessary transparently determining what data to replicate in a bandwidth efficient manner. The present system therefore provides storage of content to a user without user concern for data layout or replication.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a personal storage system according to the present teachings;

FIG. 2 illustrates an example of a data entity layout that could be used by the storage manager;

FIG. 3 shows a method for storing user media content according to the present techniques;

FIG. 4 shows a method for retrieving user media content according to the present techniques.

### DETAILED DESCRIPTION

FIG. 1 shows a storage system 100 according to the present teachings. The storage system 100 includes a storage user interface 101 that through a media interface 102 provides user access to input personal content in the form of local temporary media 107 or remote media 108 such as a remote web site. Other embodiments may store non-personal content such as company records or medical data.

Those practiced in the art of storage will recognize many forms of source (107 and 108) for personal content may exist. Example embodiments presented in this teaching include flash cards and compact discs. In addition, while the present techniques cover the storage of personal data, those practiced in the art will recognize that other types of content, for example shared or company content, may also be stored by the present teachings.

The storage management system 103 takes the content 107 and 108 through content related abstractions presented through the user interface 101 and transparently organize the source personal content onto an internal storage device 110. A typical embodiment of internal storage may use a conventional hard disk drive but other embodiments exist.

The storage management system 103 uses content related abstractions to allow the user in input content in a way that does not refer to the organization of the content in internal storage 110. One embodiment might be the use of films, photo albums, and a scrapbook as means of expressing the storage of pictures. Another embodiment may use shelves, title and genre as a means of storing video (home video or commercial). Using this abstraction, the management system 103 not only determines where to initially store content, but also how to break up parts of the content into related data items and how to maintain/continue the abstraction when content is edited or annotated. One embodiment, might keep revisions of photo edits in a scrapbook as far as the user is concerned. While underneath copies of edits are kept in multiple directories with an original copy placed in yet another directory. Annotations at each edit may be stored at text files associated with the edited image. Relationships between these items may further be stored in an database.

In presenting a content related abstraction to the user, the management system 103 may create one or more data entities on the internal storage device 110 to represent the original source media 107 and 108. Where a data entity is a unit of storage used to represent a version or type of data associated with the source content.

The media storage manager 103 also decides what part of the stored data entities should be replicated in order to deliver a particular level of reliability. The level of reliability provided by the system may be determined by the system initially or dynamically. The embodiment present here describes a system where the level of reliability is determined by the system when created. In this embodiment, hardware is provided in the system for a certain level of service in accordance to the purchaser's requirements. This may be a secondary internal disk 109 or a network connection 112.

Using the level of data integrity set in the media manager 103, it decides which data entities on the internal storage 110 requires replication and uses the remote backup agent 104 to replicate on to secondary storage. Secondary storage could, for example, be internal storage 109 or remotely through a network link 112 to a remote site 111.

In doing so, the manager 103 may only select part of the stored content for replication in order to use the network link 112 efficiently. A typical embodiment may maintain multiple copies and versions of personal content as well as metadata regarding that personal content. Since this data is interrelated, the manager 103 may use the relationships to determine what data entities to replicate and which can be reproduced from the source content rather than all being transferred to secondary storage.

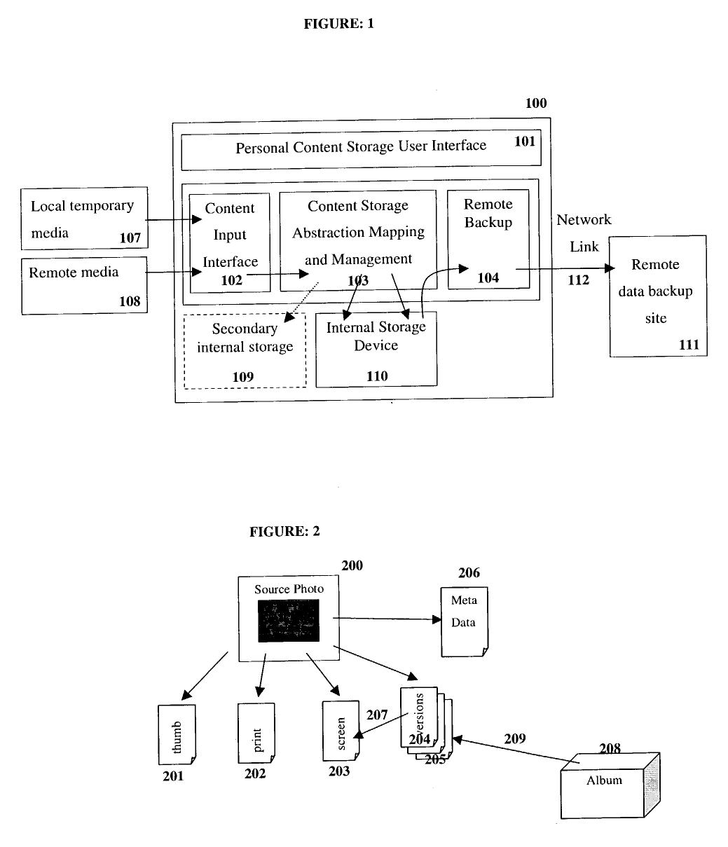

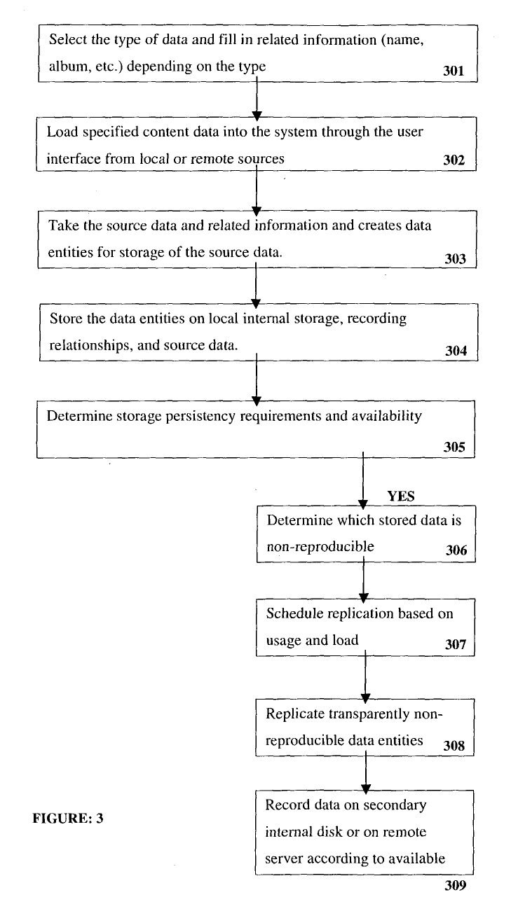

FIG. 2 shows a typical embodiment of the layout used by the media manager 103 to store source content for a photograph 200. In this embodiment, the manager 103 takes the source content 200 and creates four or more versions of that content in the form of ‘data entities’ for storage. Typical data entities created may include: a thumbnail image 201, a print corrected version of the image 202, a screen resolution version 203, one or more revisions to the image 204-205, and related metadata 206 such as user comments on the source photo 200. In addition, relationships may be kept between data entities created to express content structure. A revision may contain a relationship 207 to the appropriate screen or print version of the data. In addition, an album entity 208 may have recorded relationships 209 to certain revisions of the source content 204 to 205.

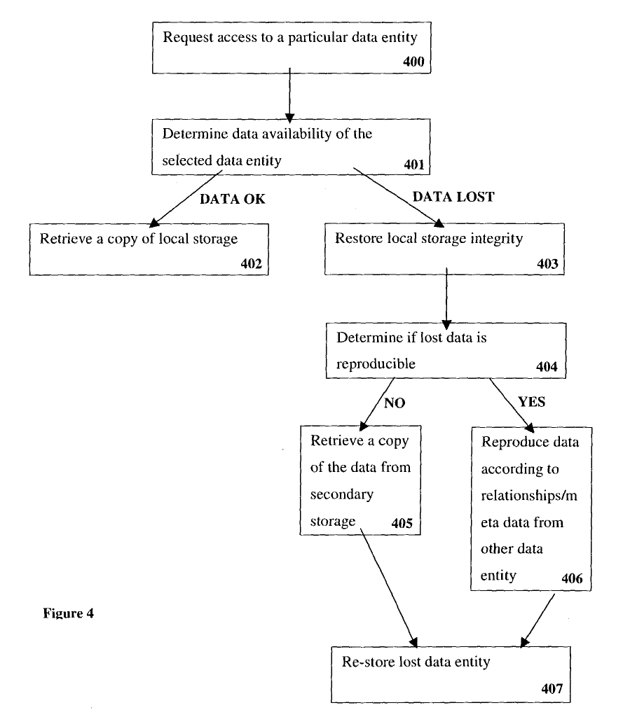

FIG. 3 shows a method for storing source user media content 107 and 108 according to the present techniques. The source media represent user content that needs to be stored and collated permanently for the user. At step 301, the user selects the type of information to store into the device, if this information cannot be determined automatically. For example, this may be photograph, video clip, or document.

At step 302, the data representing the source content 107 and 108 is loaded into the system through the user interface from local 107 or remote 108 sources.

At step 303, the media manager of the system 103 takes the data and related information entered in steps 301 and 302 and creates data entities to represent the source media. A data entity represents a unit of data storage used to encapsulate information regarding the source media. For example, a data entity may be a reduced resolution version thumbnail image 201 of the source data 200. Data entities contain derived information from the source data 200 created automatically by the manager 103 to represent the source data or versions thereof.

In step 304, the manager 103 stores the data entities on the local internal storage 110 in accordance to the created data entities and source content type. In one embodiment, the manager may store revisions of the source content in a file system directory per revision. Alternatively, the manager may store revisions in an object database indexed by the source content as primary key to obtain the revision relationship to other versions and other data entities. However, those experienced in the art will understand other storage layouts and methods fall in this scope.

In step 305, the system determines whether replication is required to support the level of data permanency embodied in the system. In one embodiment, the system may have provided a secondary internal disk to protect against failure of the primary storage device. Alternatively or additionally, the system may have been provided with a network link enabling Internet access to allow the system to replicate data remotely to protect against complete system damage. This determination may be made at system creation time or dynamically depending on installed hardware or by some other method.

In another embodiment, a system may be configured to only to protect against software failures or temporal internal storage problems. In such cases, a secondary storage location on alter hardware is not required. Instead, the manager 103 may store replicas elsewhere on the internal storage device to prevent certain forms of data loss. However, those experienced in the art will understand may other levels of permanence may be supported with various configurations. Using the configurations, the present technique uses application knowledge of data relationships and reproducibility to replicate onto these stores.

In step 306, if replication is required the system determines in any of the newly created data entities are reproducible from other entities. For example, new personal content is not initially reproducible. However, copied content or versions of data entities may be reproducible.

In step 307, the system schedules the replication of the non-reproducible data entities. One embodiment may wait until the system or network link are not in use to allow the most efficient replication of the data entities.

Step 308, data entities are replicated on to the secondary storage location. Steps 305 through 309 are transparent to the user. Therefore, replicated data is available even before it has been replicated, as well as during and after. Data entities may be replicated using many methods. One embodiment may duplicate the data entity all any related information and data entities completely. Other embodiments may minimize the data that must be replicated in order to minimize backup storage requirements.

Step 309, records the replicated data to the secondary storage location determined by the manager 103 at step 305.

If no replication is required in step 305, the data is permanently archived on the local disk according to the abstraction presented by the media manager 103.

FIG. 4 shows a method for retrieving data entities from the system according to the present techniques. At step 400, a request is made by a user of the system for a particular piece of media content. This is mapped by the manager 103 to a request for a particular data entity (or entities) from the internal store. For example, a user may wish to print a piece of photographic content. This requires a version of the source data formatted for printing; this data requires a particular data entity.

In step 401, the system determines whether the data entity is available for access. For example, hardware and software failures may have corrupt or lost data. Techniques such as cyclic redundancy checksums can be used to infer this.

If data is available, it may be directly retrieved in step 402. If data was lost, step 403 restores local storage integrity.

In step 404, the system determines whether the data is reproducible from other data entities. For example, data such as copies of photographs in other albums along with relevant metadata may be used to reproduce data.

If data may be reproduced in step 406 the data is reproduced from other intact data entities. Otherwise, in 405 the data is retrieved from a secondary storage location.

In step 407, the restored data is stored again on the local storage device.

In another embodiment of the disclosed techniques, data entities derived from source content may not be stored on the local storage. Instead, the system may only store information on how to reproduce the data. For example, the system may record the data was converted to the CMYK color space and reduced to 150 dots per inch for a print version of a source photograph. Those practiced in the art will understand this is an optimization and is within the scope of the forementioned techniques.

The foregoing detailed description of the present invention is provided for the purposes of illustration and is not intended to be exhaustive or to limit the invention to the precise embodiment. Accordingly, the scope of the present invention is defined by the appended claims.

What is claimed is:

1. A method of storing content, comprising the steps of:
Transparently mapping content into a set of underlying data content by using a content abstraction;
Storing the data content and their content relationships permanently transparently on local media according to the content type abstraction;
Determining whether to replicate data;
Determining whether to recover data.

2. The method of claim 1, wherein the step of transparently mapping comprises taking media such as electronic images representing photographs.

3. The method of claim 2, wherein the step of transparently mapping comprises the step of using content attributes rather than file system structure to determine how to store the content.

4. The method of claim 3, wherein the step of transparently mapping comprises the step of taking content from physically local sources such as a flash memory card.

5. The method of claim 3, wherein the step of transparently mapping comprises the step of taking content from remote sources such as Internet web sites.

6. The method of claim 5, wherein the step of transparently mapping comprises the step of determining a set of one or more pieces of related data entities from a piece of input content.

7. The method of claim 6, wherein the step of transparently mapping comprises the step of determining and recording the relationships of between created data entities, such as print version images and screen images.

8. The method of claim 7, wherein the step of transparently mapping comprises the step of maintaining the relationship between data entities as changes are made to the content or data entities.

9. The method of claim 1, wherein the step of storing entities comprises the step of transparently determining a location based on data entity type and attributes where to physically store data.

10. A method for determining when to replicate data, comprising the steps of:
Determining the level of replication that may be supported;
Determining which data entities needs to be replicated;
Replicating data that requires replication.

11. The method of claim 10, wherein the step of determining the level of replication comprises the step of determining backup storage in the form of local secondary storage.

12. The method of claim 10, wherein the step of determining the level of replication comprises the step of determining backup storage in the form of remote secondary storage.

13. The method of claim 10, wherein the step of determining the level of replication comprises the step of determining a level of data integrity from the result of claims 12 and 13 provided by the hardware.

14. The method of claim 10, wherein the step of determining the level of replication comprises the step of transparently determining what replication to support based on the embodying devices' data integrity characteristics.

15. The method of claim 10, wherein the step of determining which data entities to replicate comprises the step of determining whether data entities have already been replicated.

16. The method of claim 15, wherein the step of determining which data entities to replicate comprises the step of determining whether unreplicated data can be transparently reproduced from existing data entities.

17. The method of claim 16, wherein the step of determining which data entities to replicate comprises the step of using type, attributed and/or relationships to transparently determine what data needs replicating.

18. A method for determining when to recover data, comprising the steps of:
Determining existing data integrity;
Determining how to obtain a backup copy of the data
Recovering a backup copy.

19. The method of claim 18, wherein the step of determining how to obtaining a backup copy comprises the step of transparently determining from other data or relationships whether the data made be reproduced from existing data.

20. The method of claim 18, wherein the step of recovering a backup copy, comprises the step of transparently transforming existing backup into the required content.
